(19) United States
(12) Patent Application Publication
(10) Pub. No.: US 2026/0327116 A1
(43) Pub. Date: Oct. 22, 2026

(54) METHOD FOR ACCOUNTING CARBON EMISSION DURING TREATING DOMESTIC WASTE LEACHATE

(71) Applicant: ACADEMY OF ENVIRONMENTAL SCIENCES, Beijing (CN)

(72) Inventors: Xiaosong HE, Beijing (CN); Beidou XI, Beijing (CN); Li TAN, Beijing (CN); Shule LIU, Beijing (CN); Zhanyun MA, Beijing (CN)

(73) Assignee: ACADEMY OF ENVIRONMENTAL SCIENCES, Beijing (CN)

(21) Appl. No.: 19/430,401

(22) Filed: Dec. 23, 2025

(30) Foreign Application Priority Data
Nov. 27, 2025 (CN) 2025117601136

(51) Int. Cl. C02F 9/00; C02F 1/04; C02F 1/44; C02F 1/72; C02F 3/12; C02F 3/28; C02F 103/06

(52) U.S. Cl. CPC C02F 9/00; C02F 1/048; C02F 1/441; C02F 1/442; C02F 1/72; C02F 3/1268; C02F 3/28; C02F 2103/06; C02F 2209/28; C02F 2209/34

(57) ABSTRACT

The present invention discloses a method for accounting carbon emissions during treating domestic waste leachate, and the method comprises the following steps: classifying treatment processes by types of waste treatment plants and corresponding leachate treatment processes; constructing a set of discharge factors in unit mass for each of treatment processes, and the factors include direct discharge factors and indirect discharge factors; obtaining total amount of carbon emissions in a region, based on the set of discharge factors, total treatment amount of waste leachate in the region, and the treatment ratio of each of treatment processes.

### CROSS-REFERENCE TO RELATED APPLICATIONS

This application claims priority to Chinese Patent Application Ser. No. CN2025117601136 filed on 27 Nov. 2025.

### TECHNICAL FIELD

The present invention relates to a method for accounting carbon emission during treating domestic waste leachate, and belongs to the field of carbon emission/discharge/disposal technology.

### BACKGROUND ART

In the prior art, much of the research for domestic waste carbon emissions has focused on the solid waste itself, in which 10% of the organic matters in the solid waste is discharged by leachate run-off, and the use of biological treatments, chemicals and energy during leachate treatment results in carbon emissions. Discharges vary depending on leachate treatment processes, and carbon emissions resulting from leachate treatment can be non-trivial. As domestic waste production continues to increase, carbon emissions resulting from waste leachate treatment will rise year-by-year.

Existing domestic waste/garbage carbon emissions have generally ignored greenhouse gas discharges during the leachate treatment. Even part of the study relates to the leachate, also fails to refine accounting by types of treatment processes, resulting in low confidence and precision of the results. Existing accounting methods often miss sources such as electricity consumption, chemicals/medicaments, and membrane components/modules, and lack of uniform, multiplexable factors for integrated carbon emissions. The discharge factors used in the current study are largely derived from the discharge factors of sewage in IPCC guidelines, which differ greatly from the water of the leachate in qualities, and replacement discharge factors of the leachate with those of the sewage may underestimate the carbon emissions during leachate treatment phase and reduce the accuracy of the emission results.

Therefore, there is need for more intensive investigation into carbon emissions accounting methods for existing domestic/household waste leachate treatment, to address above-mentioned problems and achieve more accurate carbon emissions/disposal/discharge results.

### SUMMARY OF THE INVENTION

In order to overcome the above-mentioned problems, intensive research is carried out, and a method for accounting carbon emissions during treating domestic waste leachate is provided.

The present method comprises the following steps:
S1. classifying treatment processes by types of waste treatment plants and corresponding leachate treatment processes;
S2. constructing a set of discharge factors in unit mass for each of treatment processes, and said factors include direct discharge factors and indirect discharge factors;
S3. obtaining total amount of carbon emissions in a region, based on the set of discharge factors, total treatment amount of waste leachate in the region, and the treatment ratio of each of treatment processes.

According to a preferred embodiment, in S1, said types of waste treatment plants include landfills and incineration plants,
Wherein,
Leachate treatment processes in landfills include five treatment processes, such as membrane bioreactor-nanofiltration/reverse osmosis, two-stage disc tube reverse osmosis, biochemical-advanced oxidation, mechanical evaporation, and others.

Leachate treatment processes in incineration plants include two treatment processes, such as anaerobic biotreatment-membrane bioreactor-nanofiltration/reverse Osmosis, and others.

According to a preferred embodiment, in S2, said direct discharge factors include CH₄ factor and N₂O factor.

The indirect discharge factors include electricity consumption factor, chemical consumption factor, and membrane consumption factor.

In a preferred embodiment, a factor database is established for each factor, and said factor database is stored with factor values acquired based on the data from different domestic waste treatment plants.

In a preferred embodiment, factor values in the factor database are filtered to remove the data which have apparent deviation.

In a preferred embodiment, distribution statistics are also performed on the factor values in the factor database, confirming the type of data distribution.

In a preferred embodiment, the CH₄ factor is obtained by the equation as follows:

EF_{CH4}=(CODᵢₙ−CODₒᵤₜ)×f_{CH4}×GWP_{CH4}
Wherein
EF_{CH4} represents the discharge factor of CH₄ resulting from leachate treatment process of waste treatment plant,
CODᵢₙ represents average incoming water COD concentration during leachate treatment,
CODₒᵤₜ represents average outgoing water COD concentration during leachate treatment,
f_{CH4} represents CH₄ emission amount corresponding to removal COD per unit, and
GWP_{CH4} represents global warming potential of CH₄.

The N₂O factor is obtained by the equation as follows:

EF_{N2O}=(TNᵢₙ−TNₒᵤₜ)×f_{N2O}×28/44×GWP_{N2O}
Wherein,
EF_{N2O} represents N₂O discharge factor resulting from leachate treatment of waste treatment plant,
TNᵢₙ represents average incoming water TN concentration during leachate treatment,
TNₒᵤₜ represents average outgoing water TN concentration during leachate treatment,
f_{N2O} represents N₂O discharge corresponding to removal TN per unit, and
GWP_{N2O} represents global warming potential of N₂O.

In a preferred embodiment, said electricity consumption factor is expressed as:

EF_{elec}=f_{elec}×E
Wherein,
EF_{elec} represents the electricity consumption factor,
f_{elec} represents the CO₂ discharge amount corresponding to the electricity consumption, and
E represents the total electricity consumption amount during the leachate treatment of the waste treatment plant.

The chemical consumption factor is expressed as:

EF_{chem}=Σmⱼ×fⱼ
Wherein,
mⱼ represents the j^{th} chemical consumption amount in units of kg/m₃; and
fⱼ represents the carbon footprint of the j^{th} chemical.

The membrane consumption factor is expressed as:

EFₘₑₘ=n×f_{mod}
Wherein,
EFₘₑₘ represents the membrane consumption factor,
n represents the number of membrane modules needed to replace to treat 1 m³ leachate; and
f_{mod} represents the carbon footprint of the membrane modules for different types of membranes.

According to a preferred embodiment, in the membrane bioreactor-nanofiltration/reverse osmosis treatment process, CH₄ discharged from the anaerobic/aerobic unit is accounted for the CH₄ factor and N₂O discharged from the anaerobic/aerobic unit is accounted for the N₂O factor.

In the biochemical-advanced oxidative treatment process, CH₄ discharged from the anaerobic/aerobic unit and the aerated biological filter is accounted for the CH₄ factor and N₂O discharged from the anaerobic/aerobic unit and the aerated biological filter is accounted for the N₂O factor.

In the anaerobic biotreatment-membrane bioreactor-nanofiltration/reverse osmosis treatment process, CH₄ discharged from anaerobic biotreatment is not accounted for the CH₄ factor, but CH₄ discharged from membrane bioreactor is accounted for the CH₄ factor.

According to a preferred embodiment, in S3, multiple simulations are performed using Monte Carlo simulation method, based on the factor database, total treatment amount of waste leachate within the region, and the treatment ratio of each of treatment processes, and the median value of simulation results is as final total carbon emission amount within the region.

The present invention have benefits, which including the follows:
(1) greenhouse gas discharge factors for different leachate treatment processes are established, and by means of setting up a factor database, the problems, such as large differences in data between different waste treatment plants and inability to obtain accurate factor values are solved.
(2) The problem from leachate treatment of greenhouse gas discharges directly utilizing municipal sewage treatment greenhouse gas discharge factors which resulting in less accounted amounts is solved.
(3) Other discharge factors of leachate treatment and total emissions amount in a region is determined by using Monte Carlo simulation method and large data from leachate treatment plants in different regions, and the accounting results are more realistic.

### DESCRIPTION OF FIGURES

FIG. 1 is a schematic flow diagram illustrating accounting method for carbon emissions during domestic waste leachate in accordance with a preferred embodiment of the present invention;

FIG. 2 shows the CH₄ factor and the N₂O factor for leachate treatment in landfill by membrane bioreactor-nanofiltration/reverse osmosis process and biochemical-advanced oxidation process in Example 1;

FIG. 3 shows the electricity consumption factor for each of leachate treatment processes in landfill in Example 1;

FIG. 4 shows the chemical consumption factor for each of leachate treatment processes in landfill in Example 1;

FIG. 5 shows membrane consumption factor for each of leachate treatment processes in landfill;

FIG. 6 shows the CH₄ factor and the N₂O factor for leachate treatment by anaerobic biotreatment-membrane bioreactor-nanofiltration/reverse osmosis in incineration plant;

FIG. 7 shows the electrical consumption factors and chemical consumption factor for leachate treatment processes in incineration plant;

FIG. 8 shows total amount of greenhouse gas emissions results from Monte Carlo simulation of leachate treatment in landfill;

FIG. 9 shows total amount of greenhouse gas emissions results from Monte Carlo simulation of leachate treatment in incineration plant.

### DETAILED DESCRIPTION OF INVENTION

The present invention will be described in further detail below by means of the accompanying drawings and examples. The characteristics and advantages of the present invention will become clearer from these descriptions.

The word “exemplary” is used exclusively herein to mean “serving as example, embodiment, or illustration.” Any embodiment described herein as “exemplary” is not necessarily to be construed as preferred or advantageous over other embodiments. Although various aspects of embodiments are shown in drawings, drawings are not necessarily drawn to scale, unless specifically noted.

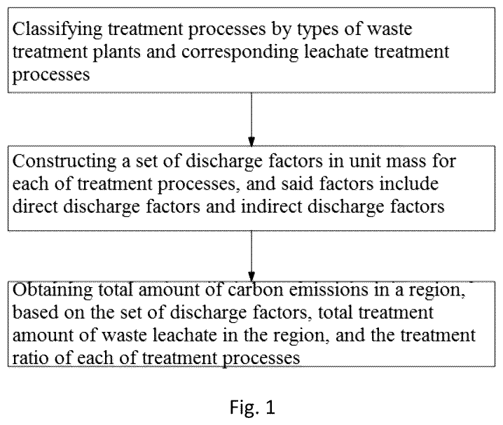

In accordance with the present invention, a method for accounting carbon emissions during treating domestic waste leachate is provided, as illustrated in FIG. 1, comprising the steps of:
S1. classifying treatment processes by types of waste treatment plants and corresponding leachate treatment processes;
S2. constructing a set of discharge factors in unit mass for each of treatment processes, and said factors include direct discharge factors and indirect discharge factors;
S3. obtaining total amount of carbon emissions in a region, based on the set of discharge factors, total treatment amount of waste leachate in the region, and the treatment ratio of each of treatment processes.

In a preferred embodiment, in S1, the types of waste treatment plants include landfills and incineration plants.

Said leachate treatment processes in landfills include five treatment processes, such as membrane bioreactor-nanofiltration/reverse osmosis, two-stage disc tube reverse osmosis, biochemical-advanced oxidation, mechanical evaporation, and others.

Said leachate treatment processes in incineration plants include two treatment processes, such as anaerobic biotreatment-membrane bioreactor-nanofiltration/reverse osmosis, and others.

In S2, said direct discharge factors include CH₄ factor and N₂O factor.

Said indirect discharge factors include electricity consumption factor, chemical consumption factor, and membrane consumption factor.

According to the present invention, said CH₄ factor is used to characterize the gas coefficient of CH₄ produced directly in the treatment process.

Said N₂O factor is used to characterize gas coefficient of N₂O produced directly in the treatment process.

Said chemical consumption factor is used to characterize an coefficient of greenhouse gases which indirectly resulting from the use of chemical agents during treating leachate.

Said electricity consumption factor is used to characterize an coefficient of greenhouse gases which indirectly resulting from the electrical energy used during leachate pipeline transport and hydraulic lift, air blast aeration and other equipment electricity.

Said membrane consumption factor is used to characterize an coefficient of greenhouse gases which indirectly resulting from consumption of added carbon sources, coagulants, membrane washers, membrane modules.

Said direct discharge factors and indirect discharge factors, define greenhouse gas emission accounting boundaries, which including only three fractions, namely, direct discharges in biological treatment process, indirect discharges resulting from electrical energy consumption, and indirect discharges resulting from consumables use, and precluding off-stage discharges, such as sludge treatment and conditioning pond runaway, to avoid duplication or omission as for system boundaries.

According to a preferred embodiment, in the membrane bioreactor-nanofiltration/reverse osmosis treatment process, CH₄ discharged from the anaerobic/aerobic unit is accounted for the CH₄ factor and N₂O discharged from the anaerobic/aerobic unit is accounted for the N₂O factor.

In biochemical-advanced oxidative treatment process, CH₄ discharged from the anaerobic/aerobic unit and the aerated biological filter is accounted for the CH₄ factor and N₂O discharged from the anaerobic/aerobic unit and the aerated biological filter is accounted for N₂O factor.

In anaerobic biotreatment-membrane bioreactor-nanofiltration/reverse osmosis treatment process, CH₄ discharged from leachate anaerobic unit is not accounted for the CH₄ factor. The reason is that methane produced from anaerobic biotreatment is able to be collected and used by incineration to produce carbon dioxide, thus CH₄ is not emitted to atmosphere.

This process defines accounting boundaries, and the discharge/disposal data of leachate treatment through different processes are comparable by setting clear, consistent accounting boundaries for different processes. CH₄ discharged from leachate anaerobic unit of the incineration plant is classified to the incineration process, which fundamentally prevents the same carbon source from being repeatedly accounted in both waste incineration and leachate treatment, and ensures accurate calculations of the total amount of greenhouse gas discharged across the plant.

According to the present invention, the CH₄ factor is obtained by the following equation:

EF_{CH4}=(CODᵢₙ−CODₒᵤₜ)×f_{CH4}×GWP_{CH4}
Wherein,
EF_{CH4} represents the discharge factor of CH₄ resulting from leachate treatment process of waste treatment plant, in units of kg CO₂-eq/m₃;
CODᵢₙ represents average COD concentration of incoming water during leachate treatment, in units of mg/L;
CODₒᵤₜ represents average COD concentration of outgoing water during leachate treatment, in units of mg/L;
f_{CH4} represents CH₄ emission amount corresponding to removal COD per unit, preferably in the range [0.001, 0.0429] in units of kg CH₄/kg COD, more preferably 0.0077 kg CH₄/kg COD; and
GWP_{CH4} represents global warming potential of CH₄, which is an empirical value, preferably with a value of 28.

The N₂O factor is obtained by the equation as follows:

EF_{N2O}=(TNᵢₙ−TNₒᵤₜ)×f_{N2O}×28/44×GWP_{N2O}
Wherein,
EF_{N2O} represents the discharge factor of N₂O resulting from leachate treatment process, in units of kg CO₂-eq/m₃;
TNᵢₙ represents average TN concentration of incoming water during leachate treatment, in mg/L;
TNₒᵤₜ represents average TN concentration of outgoing water during leachate treatment, in mg/L;
f_{N2O} represents N₂O emission amount corresponding removal TN per unit, in the range [0.000298, 0.1774] in units of kg N₂O/kg TN, preferably 0.05322 kg N₂O/kg TN; and
GWP_{N2O} represents global warming potential of N₂O, which is an empirical value, with a value of 265.

The electricity consumption factor is expressed as:

EF_{elec}=f_{elec}×E
Wherein,
EF_{elec} represents the electricity consumption factor, and
f_{elec} represents CO₂ emission amount corresponding to the electricity consumption, with a value taken preferably with reference to the “National Electricity Carbon Footprint Factor of 2023” published by the Department of Ecological Environment, National Bureau of Statistics and National Energy Bureau; and
E represents total electricity consumption amount during leachate treatment process, in units of kW·h/m₃.

The chemical consumption factor is expressed as:

EF_{chem}=Σmⱼ×fⱼ
Wherein,
mⱼ represents the j^{th} chemical consumption amount in units of kg/m₃; and
fⱼ represents the carbon footprint (discharge coefficient) of the j^{th} chemical in units of kg CO₂-eq/kg.

Specific values for carbon footprints of chemicals can be set empirically by one skilled in art, for example to values as shown in Table 1.

TABLE 1
carbon footprints of different chemicals/chemical agents

| | | Discharge coefficient |
|---|---|---|
| No. | Names of chemicals | (kgCO₂-eq · kg⁻¹) |
| 1 | hydrochloric acid | 1.20 |
| 2 | defoamer | 3.00 |
| 3 | microbicide | 0.92 |
| 4 | polyaluminium chloride(PAC) | 1.62 |
| 5 | polyacrylamide | 1.50 |
| 6 | liquid caustic | 1.12 |
| 7 | methanol | 1.54 |
| 8 | quicklime | 1.1 |
| 9 | hydrated lime | 0.68 |
| 10 | hydrogen peroxide solution | 1.14 |
| 11 | sulfuric acid | 0.16 |
| 12 | sodium hydroxide | 1.12 |
| 13 | acetic acid | 0.852 |
| 14 | sodium acetate | 0.623 |
| 15 | other Flocculants | 2.5 |
| 16 | other sanitizer | 1.4 |
| 17 | other chemical agents | 1.60 |

The membrane consumption factor is expressed as:

EFₘₑₘ=n×f_{mod}
Wherein,
EFₘₑₘ represents the membrane consumption factor;
n represents the number of membrane modules needed to replace to treat 1 m³ leachate;
and

f_{mod} represents the carbon footprint of different types of membrane modules, in units of kg CO₂ per membrane module.

Specific values for carbon footprint of different types of membrane modules can be set empirically by one skilled in art, for example, to values as shown in Table 2.

TABLE 2
carbon footprint of different types of membrane modules

| | Discharge factors of |
|---|---|
| | greenhouse gases (kg CO₂ |
| Type | per membrane modules) |
| ultrafiltration membrane (UF) | 89.3 |
| nanofiltration membrane (NF) | 82.1 |
| reverse osmosis membrane (RO) | 87.7 |

It is found that, although more accurate discharge factors can be calculated using the above formula, however, in actual use, the same factor is not the same in different domestic waste treatment plants, which results in that it is not possible to estimate carbon emissions over a wide range of areas from the factor values obtained by one waste treatment plant during actual accounting, and how to obtain more accurate estimates of carbon emissions over a region is difficult.

In the present invention, a factor database is established for each factor, in which factor values acquired based on data from different domestic/household waste treatment plants are stored.

Preferably, at least 40 factor values are included in said factor database, i.e. the factors acquired based on data from at least 40 domestic waste treatment plants are combined to form corresponding factor database.

Preferably, a sample size of more than 300 landfills and 50 incineration plants in different regions and on different scales is employed, ensuring good representativeness and pervasiveness of constructed discharge factors, to overcome bias in previous studies and IPCC guidelines due to small sample sizes or a single source of data. By employing measured and operational statistics derived from actual engineering, errors brought by direct suite sewage discharge factors are fundamentally avoided, making accounting results closer to practical, providing a reliable basis for accurate greenhouse gas accounting and greenhouse gas abatement decisions.

In a preferred embodiment, factor values in the factor database are also filtered/screened to remove data which has apparent deviation.

The particular method of filtering is not limited in the present invention and is freely selectable by one skilled in the art empirically.

Preferably, distribution statistics are also performed on values in the database of factors, confirming the types of data distribution, e.g. normal distribution, binomial distribution, exponential distribution, etc.

In S3, multiple simulations are performed using Monte Carlo simulation method, based on the discharge factor database, total treatment amount of waste leachate within the region, and the treatment ratio of each of treatment processes, and the median value of simulation results is as final total carbon emission amount within the region.

In the actual carbon emissions estimation, it is difficult to obtain leachate throughput per waste treatment plant, as well as throughput data of each treatment process per waste treatment plant. A more common statistic is the total amount of waste leachate treatment in a region. Further, the treatment ratio each of treatment processes can be obtained from waste discharge equipment, annual treatment volume estimates. And therefore, in the present invention, the total carbon emissions in the region is calculated based on the discharge factor database, the total treatment amount of waste leachate within the region, and the treatment ratio of each type of treatment processes.

Further, treatment ratio for each type of treatment processes is based on actual statistics, for example, use fraction for leachate treatment in landfills may be as shown in Table 3.

TABLE 3
use fraction of leachate treatment process in waste landfills

| | Used |
|---|---|
| Process | fraction |
| membrane biological reaction-nanofiltration/ | 0.53 |
| reverse osmosis | |
| biochemical and advanced oxidation | 0.07 |
| two-stage disc tube module reverse osmosis | 0.34 |
| mechanical evaporation | 0.03 |
| others | 0.03 |

Further, the following sub-steps are comprised in S3:
S31. obtaining the waste treatment amount of each type of treatment processes, based on the total treatment amount of waste leachate in the region and the treatment ratio/proportion of each type of treatment processes;
S32, for any type of treatment processes, randomly selecting a factor value from the factor database for each discharge factor in the set of discharge factors for that treatment process, and combinating into a discharge factor value for that treatment process;
S33, multiplying the waste treatment amount corresponding to the treatment process with the discharge factor value of the treatment process, and summing, to obtain the carbon emissions amount of the treatment process;
S34, summing the carbon emissions amount of all treatment processes to obtain total carbon emission amount in the region;
S35. repeating S32-S34 and performing plurality of simulations, and the median value obtained from plurality of simulations is as total carbon emissions amount in the region.

In S31, the ratio of leachate in total amount of waste to treat in incineration plant in a region is typically estimated as 10%-20%, preferably as 15%, in actual engineering design and operation.

Preferably, in S35, a plurality of simulations is performed using a Monte Carlo simulation method based on the distribution statistics of the factor values in the factors database. The Monte Carlo simulation method is a commonly used statistical method, and the specific process of which is not repeated in the present invention.

Various embodiments of the method described above in the present invention can be implemented in digital electronic circuitry, these various implementations may include: integrated circuitry, field programmable gate arrays (FPGA), application-specific integrated circuits (ASIC), application-specific standard products (ASSP), system-on-a-chip systems (SOC), load programmable logic devices (CPLD), computer hardware, firmware, software, and/or combinations thereof. Implemented in one or more computer programs, the one or more computer programs being executable and/or interpretable on a programmable system comprising at least one programmable processor, the programmable processors can be special or general purpose programmable processors that can receive data and instructions from, and transmit data and instructions to, a storage system, at least one input device, and at least one output device.

It will be appreciated that various forms of the processes shown above may be used, with steps reordered, added, or deleted. For example, various steps described herein may be performed in parallel, sequentially, or in different orders as long as the desired results of the disclosed subject matter are achieved, without limitation herein.

### EXAMPLES

### Example 1

Greenhouse gas discharges from leachate treatment of domestic waste landfills and incineration plants in a region in 2023 is accounted, and valid data from 317 domestic waste landfills and 57 leachate treatment stations of domestic waste incineration plants are collected. Landfill samples include 151 MBR+NF/RO processes, 87 two-stage DTRO processes, 42 Biochemical+Advanced Oxidation processes, 15 Mechanical Evaporation processes, 22 Other processes. In incineration plant samples, 48 Anaerobic+MBR+NF/RO processes are included.

The carbon emissions during domestic waste leachate treatment phase is accounted with the following steps:
S1. classifying treatment processes by types of waste treatment plants and corresponding leachate treatment processes;
S2. constructing a set of discharge factors in unit mass for each of treatment processes, and said factors include direct discharge factors and indirect discharge factors;
S3. obtaining total amount of carbon emissions in the region, based on the set of discharge factors, total treatment amount of waste leachate treatment in the region, and the treatment ratio of each of treatment processes.

In S1, said types of waste treatment plant include landfills and incineration plants, and wherein,
leachate treatment processes in landfill include five treatment processes, namely Membrane Bioreactor-Nanofiltration/Reverse Osmosis (MBR+NF/RO), Two-stage Disc Tube Reverse Osmosis (Two-stage DTRO), Biochem-Advanced Oxidation (Biochem+Advanced Oxidation), Mechanical Evaporation, and others;
leachate treatment processes in incineration plants include two treatment processes, namely Anaerobic Biotreatment-Membrane Bioreactor-Nanofiltration/Reverse Osmosis (Anaerobic+MBR+NF/RO) and others.

In S2, said direct discharge factors include CH₄ factor and N₂O factor.

The indirect discharge factors include electricity consumption factor, chemical consumption factor, and membrane consumption factor.

A factor database is established for each factor, and said factor database is stored with factor values acquired based on data from different domestic waste treatment plants.

The factor values in factor database are filtered to remove the data which have apparent deviation. Distribution statistics are also performed on factor values in the factor database, to confirm the type of data distribution.

The CH₄ factor is obtained by:

EF_{CH4}=(CODᵢₙ−CODₒᵤₜ)×f_{CH4}×GWP_{CH4}

The N₂O factor is obtained by:

EF_{N2O}=(TNᵢₙ−TNₒᵤₜ)×f_{N2O}×28/44×GWP_{N2O}

The electricity consumption factor is expressed as:

EF_{elec}=f_{elec}×E

The chemical consumption factor is expressed as:

EF_{chem}=Σmⱼ×fⱼ

The membrane consumption factor is expressed as:

EFₘₑₘ=n×f_{mod}
Wherein, the value of GWP_{CH4} is 28 and the value of GWP_{N2O} is 265.

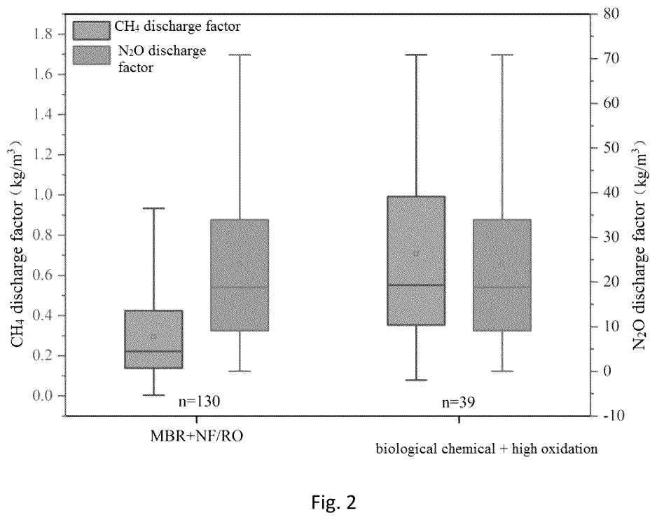

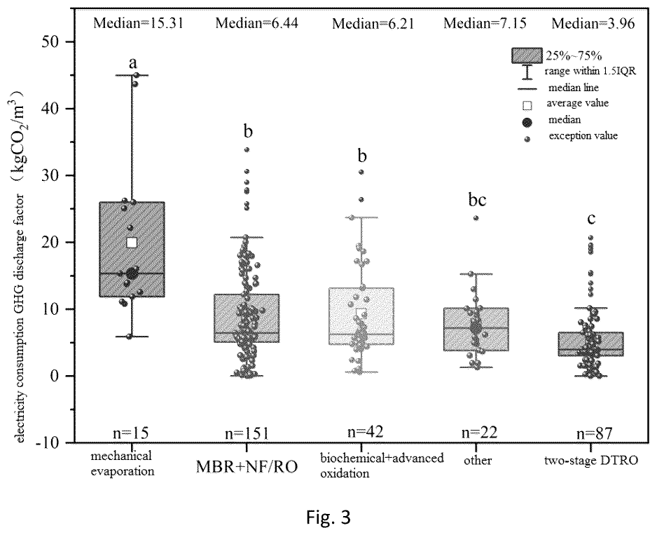

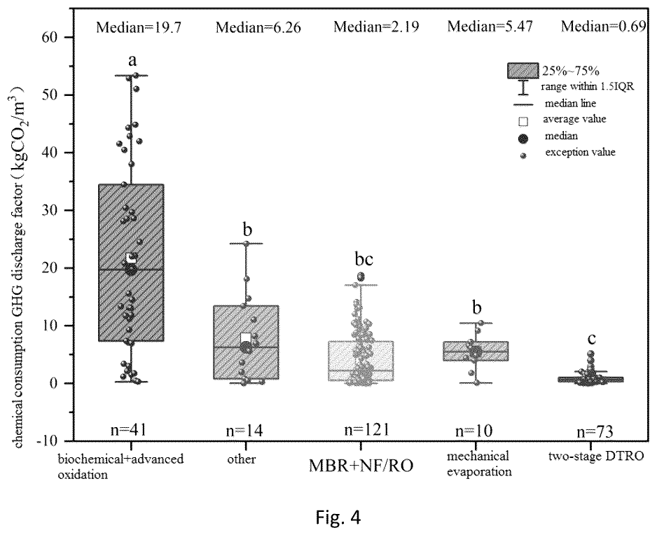

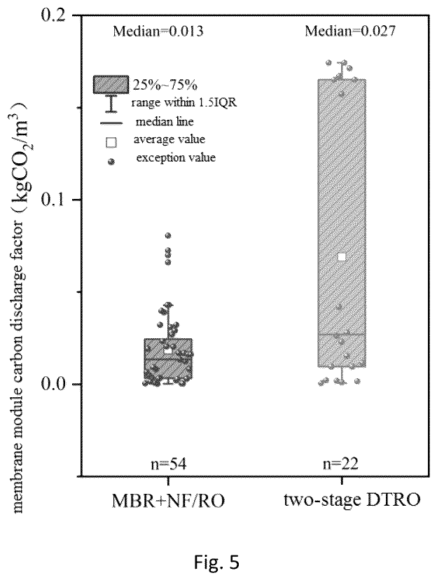

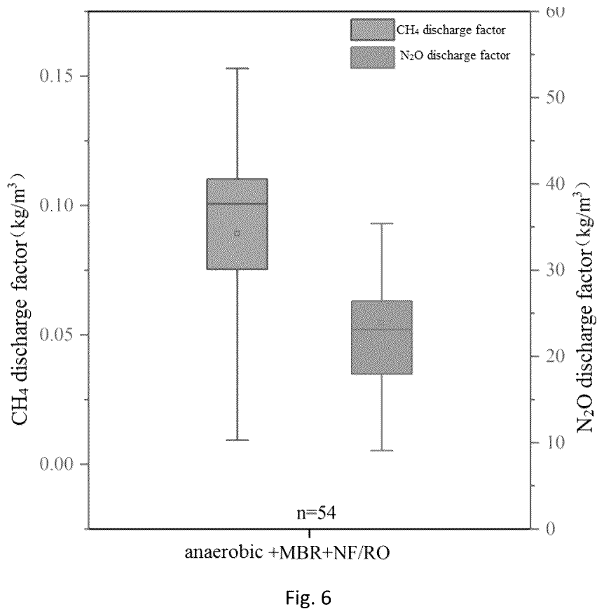

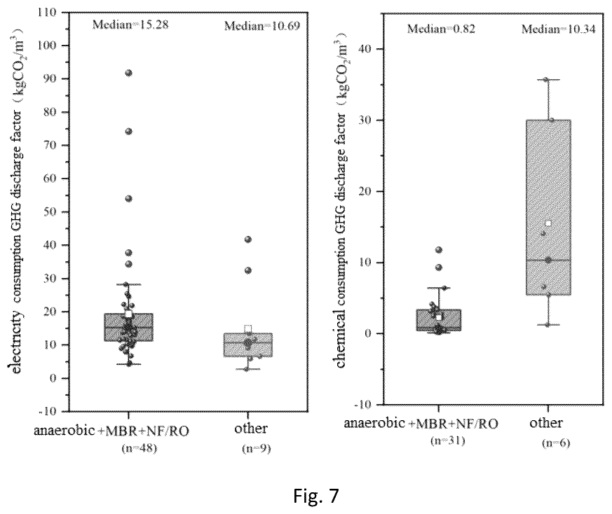

The obtained CH₄ factors for membrane bioreactor-nanofiltration/reverse osmosis (MBR+NF/RO), biochemical-advanced oxidation (Biochem+Advanced oxidation), and N₂O factors for membrane bioreactor-nanofiltration/reverse osmosis (MBR+NF/RO), biochemical-advanced oxidation (Biochem+Advanced oxidation) are shown in FIG. 2;
the electricity consumption factors for leachate treatment processes in landfills are shown in FIG. 3;
the chemical consumption factors for leachate treatment processes in landfills are shown in FIG. 4;
the membrane consumption factors for leachate treatment processes in landfills are shown in FIG. 5;
the CH₄ factors and N₂O factors for leachate treatment by Anaerobic Biotreatment-Membrane Bioreactor-Nanofiltration/Reverse Osmosis in incineration plants are shown in FIG. 6, and
the electricity consumption factors and chemical consumption factors for leachate treatment processes in incineration plants are shown in FIG. 7.

In the membrane bioreactor-nanofiltration/reverse osmosis treatment process, CH₄ discharged from the anaerobic/aerobic unit is accounted for the CH₄ factor and N₂O discharged from the anaerobic/aerobic unit is accounted for the N₂O factor.

In the biochemical-advanced oxidative treatment process, CH₄ discharged from the anaerobic/aerobic unit and the aerated biological filter is accounted for the CH₄ factor and N₂O discharged from the anaerobic/aerobic unit and the aerated biological filter is accounted for the N₂O factor.

In the anaerobic biotreatment-membrane bioreactor-nanofiltration/reverse osmosis treatment process, CH₄ discharged from anaerobic biotreatment is not accounted for the CH₄ factor.

In S3, multiple simulations are performed using Monte Carlo simulation method, based on the discharge factor database, total amount of waste leachate treatment within the region, and the treatment ratio of each of treatment processes, with the median value of simulation results is as the final total carbon emission amount within the region, and this step includes the following sub-steps:
S31. obtaining the waste treatment amount of each type of treatment processes, based on the total treatment amount of waste leachate in the region and the treatment proportion of each type of treatment processes;
S32, for any type of treatment processes, randomly selecting the factor value from the factor database for each discharge factor in the set of discharge factors for that treatment process, and combining into a discharge factor value for that treatment process;
S33, multiplying the waste treatment amount corresponding to the treatment process with the discharge factor value of the treatment process, and summing, to obtain the carbon emission amount of the treatment process;
S34, summing the carbon emissions amount of all treatment processes to obtain total carbon emission amount in the region;
S35. Repeating S32-S34, to carry out 10000 Monte-Carlo simulations, and the median value obtained for 10000 simulations is as the total carbon emissions amount in the region.

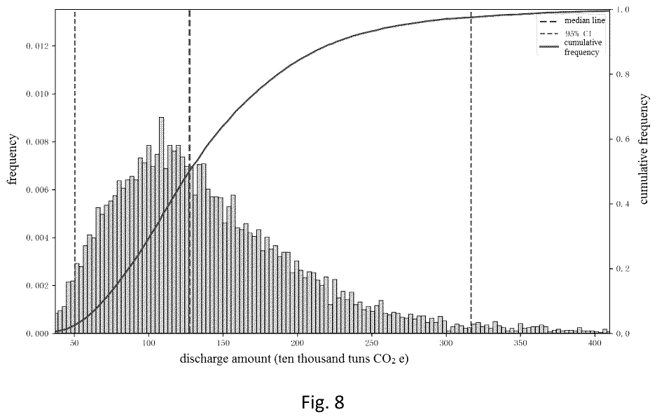

The results of Monte-Carlo simulations for the total amount of greenhouse gas discharged from leachate treatment in landfills are shown in FIG. 8, of which the median value is 128.28 CO_{2-eq} ten-thousand tons, with 95% confidence intervals of [50.63,309.4] CO_{2-eq} ten-thousand tons.

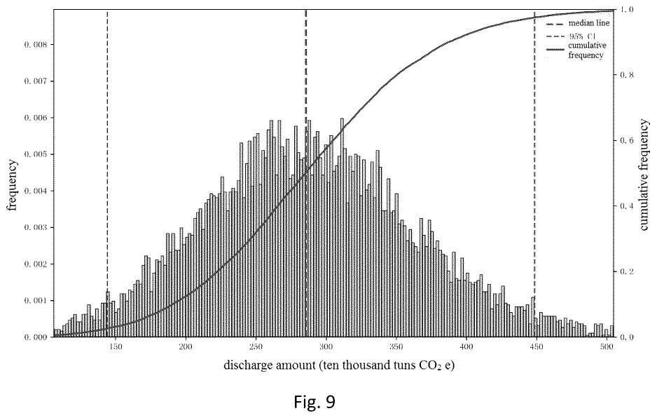

The results of Monte Carlo simulations for the total amount of greenhouse gas discharged from leachate treatment in incineration plants are shown in FIG. 9, of which the median value is 285.7 CO_{2-eq} ten-thousand tons, with 95% confidence intervals of [144.19, 448.54] CO_{2-eq} ten-thousand tons.

Compared the simulated results with statistics results from the region, deviation of less than 3% indicates that accuracy of above accounting method is high.

The invention has been described above with reference to preferred embodiments, which are nevertheless only exemplary and only illustrative. On the basis of this, numerous alternatives and modifications may be made to the invention, all falling within the scope of protection of the invention.

What is claimed is:

1. A method for accounting carbon emissions during treating domestic waste leachate, comprising the following steps of:
S1, classifying treatment processes by types of waste treatment plants and corresponding leachate treatment processes;
S2, constructing a set of discharge factors in unit mass for each of treatment processes, and said factors include direct discharge factors and indirect discharge factors; and
S3, obtaining total amount of carbon emissions in a region, based on the set of discharge factors, total treatment amount of waste leachate in the region, and the treatment ratio of each of treatment processes.

2. The method according to claim 1, characterized in that,
in the step S1, the types of waste treatment plants include landfills and incineration plants, and wherein,
leachate treatment processes in landfills include five treatment processes, such as membrane bioreactor-nanofiltration/reverse osmosis, two-stage disc tube reverse osmosis, biochemical-advanced oxidation, mechanical evaporation, and others;
leachate treatment processes in incineration plants include two treatment processes, such as anaerobic biotreatment-membrane bioreactor-nanofiltration/reverse osmosis, and others.

3. The method according to claim 1, characterized in that,
in the step S2, said direct discharge factors include CH₄ factor and N₂O factor,
said indirect discharge factors include electricity consumption factor, chemical consumption factor, and membrane consumption factor.

4. The method according to claim 3, characterized in that,
a factor database is established for each factor, in which factor values acquired based on the data from different domestic waste treatment plants are stored.

5. The method according to claim 4, characterized in that,
factor values in the factor database are filtered to remove the data which has apparent deviation.

6. The method according to claim 4, characterized in that,
distribution statistics are performed on the factor values in the factor database, confirming the type of data distribution.

7. The method according to claim 3, characterized in that,
the CH₄ factor is obtained by the equation as follows:
EF_{CH4}=(CODᵢₙ−CODₒᵤₜ)×f_{CH4}×GWP_{CH4}
wherein,
EF_{CH4} represents the discharge factor of CH₄ resulting from leachate treatment process of waste treatment plant,
CODᵢₙ represents average COD concentration of incoming water during leachate treatment,
CODₒᵤₜ represents average COD concentration of outgoing water during leachate treatment,
f_{CH4} represents CH₄ emission amount corresponding to removal COD per unit, and
GWP_{CH4} represents global warming potential of CH₄;
the N₂O factor is obtained by the equation as follows:
EF_{N2O}=(TNᵢₙ−TNₒᵤₜ)×f_{N2O}×28/44×GWP_{N2O}
wherein,
EF_{N2O} represents the discharge factor of N₂O resulting from leachate treatment of waste treatment plant,
TNᵢₙ represents average TN concentration of incoming water during leachate treatment,
TNₒᵤₜ represents average TN concentration of outgoing water during leachate treatment,
f_{N2O} represents N₂O emission amount corresponding to removal TN per unit, and
GWP_{N2O} represents global warming potential of N₂O.

8. The method according to claim 3, characterized in that,
said electricity consumption factor is expressed as:
EF_{elec}=f_{elec}×E
wherein,
EF_{elec} represents the electricity consumption factor,
f_{elec} represents CO₂ emission amount corresponding to the electricity consumption, and
E represents total electricity consumption amount during the leachate treatment of the waste treatment plant;
the chemical consumption factor is expressed as:
EF_{chem}=Σmⱼ×fⱼ
wherein,
mⱼ represents the j^{th} chemical consumption amount in units of kg/m₃; and
fⱼ represents the carbon footprint of the j^{th} chemical;
the membrane consumption factor is expressed as:
EFₘₑₘ=n×f_{mod}
wherein,
EFₘₑₘ represents the membrane consumption factor,
n represents the number of membrane modules needed to replace to treat 1 m³ leachate; and
f_{mod} represents the carbon footprint of the membrane modules for different types of membranes.

9. The method according to claim 2, characterized in that
in the membrane bioreactor-nanofiltration/reverse osmosis treatment process, the CH₄ discharged from the anaerobic/aerobic unit is accounted for the CH₄ factor, and the N₂O discharged from the anaerobic/aerobic unit are accounted for the N₂O factor;
in the biochemical-advanced oxidative treatment process, the CH₄ discharged from the anaerobic/aerobic unit and the aerated biological filter is accounted for the CH₄ factor and the N₂O discharged from the anaerobic/aerobic unit and the aerated biological filter is accounted for the N₂O factor;
in the anaerobic biotreatment-membrane bioreactor-nanofiltration/reverse osmosis treatment process, the CH₄ discharged from anaerobic biotreatment is not accounted for the CH₄ factor, but the CH₄ discharged from membrane bioreactor is accounted for the CH₄ factor.

10. The method according to claim 4, characterized in that,
in the step S3, multiple simulations are performed using Monte Carlo simulation method, based on the factor database, total treatment amount of waste leachate within the region, and the treatment ratio of each of treatment processes, and the median value of simulation results is as final total carbon emission amount within the region.
